(19) United States
(12) Patent Application Publication
(10) Pub. No.: US 2004/0017352 A1
(43) Pub. Date: Jan. 29, 2004

(54) Information processing apparatus and function assignment method for pointing device

(76) Inventor: Satoru Ishigaki, Ome-shi (JP)

Correspondence Address: Finnegan, Henderson, Farabow, Garrett & Dunner, L., 1300 I Street, N.W., Washington, DC, 20005-3315, US

(21) Appl. No.: 10/437,004

(22) Filed: May 14, 2003

(30) Foreign Application Priority Data
Jul. 23, 2002 (JP) 2002-214419

(51) Int. Cl. G09G 5/00

(52) U.S. Cl. 345/156

(57) ABSTRACT

This invention provides an information processing apparatus which has a pointing device, means for identifying the environment of the information processing apparatus, and means for executing a function corresponding to an operation of the pointing device in accordance with the identified environment.

### CROSS-REFERENCE TO RELATED APPLICATIONS

This application is based upon and claims the benefit of priority from the prior Japanese Patent Application No. 2002-214419, filed Jul. 23, 2002, the entire contents of which are incorporated herein by reference.

### BACKGROUND OF THE INVENTION

1. Field of the Invention

The present invention relates to an information processing apparatus having a pointing device, and a function assignment method for a pointing device in such information processing apparatus.

2. Description of the Related Art

When an expansion function is assigned to a pointing device such as a mouse or the like, an expansion button is added, and a function is assigned to this expansion button. If the expansion button is pressed, the function assigned to this expansion button is executed.

For example, a mouse has some expansion buttons in addition to its right and left buttons and wheel. Upon depression of one of these expansion buttons, a predetermined function is executed.

An example in which expansion buttons are provided to a mouse is disclosed in, e.g., Jpn. Pat. Appln. KOKAI Publication No. 2001-134379. This reference discloses a technique for executing a predetermined function (e.g., scroll control) when the user makes pointing operation while holding down a given expansion button.

However, with the method of assigning a function to an expansion button, the number of expansion buttons must be increased to increase the number of functions, thus disturbing intuitive operations.

In the method that combines expansion buttons and pointing operation, the number of functions can be increased to some extent without increasing the number of expansion buttons. However, it is impossible to assign a function according to a system environment (e.g., an active application program or the like) to a pointing device.

### BRIEF SUMMARY OF THE INVENTION

An information processing apparatus of the present invention comprises a pointing device, means for identifying an environment of the information processing apparatus, and means for executing a function corresponding to an operation of the pointing device in accordance with the identified environment.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below serve to explain the principles of the invention.

FIG. 1 is a view showing an outer appearance of an information processing apparatus according to an embodiment of the present invention;

FIG. 2 is a view showing a case wherein an external pointing device (mouse) is provided to the information processing apparatus;

FIG. 3 is a block diagram showing the arrangement of the information processing apparatus according to the embodiment of the present invention;

FIG. 4 is a functional block diagram of a utility program of the information processing apparatus according to the embodiment of the present invention;

FIG. 5 shows a conversion table;

FIG. 6 shows a display state of an icon corresponding to a play function to be executed when the user has operated a pointing device upward with an expansion button held down while a media player is active;

FIG. 7 shows a dialog used to set the conversion table;

FIG. 8 is a flow chart for explaining the operation of the information processing apparatus according to the embodiment of the present invention;

FIG. 9 is a flow chart for explaining the operation of the information processing apparatus according to the embodiment of the present invention;

FIG. 10 is a flow chart for explaining the operation of the information processing apparatus according to another embodiment of the present invention; and

FIG. 11 is a flow chart for explaining the operation of the information processing apparatus according to another embodiment of the present invention.

### DETAILED DESCRIPTION OF THE INVENTION

An information processing apparatus according to an embodiment of the present invention will be described hereinafter with reference to the accompanying drawings.

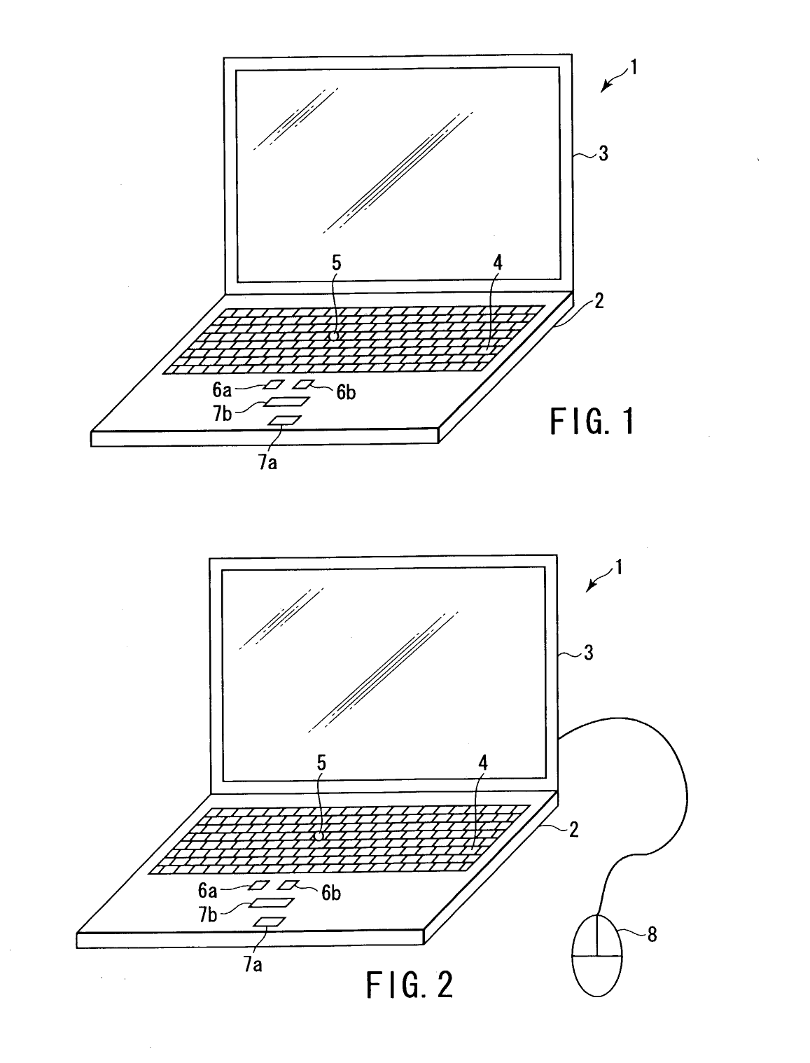

FIG. 1 shows the outer appearance of an information processing apparatus according to an embodiment of the present invention.

As shown in FIG. 1, an information processing apparatus 1 according to an embodiment of the present invention has a display unit 3 which is movably attached to a main body 2. The main body 2 has a keyboard 4, pointing device 5, expansion buttons 6a and 6b, down button (right button) 7a, and up button (left button) 7b.

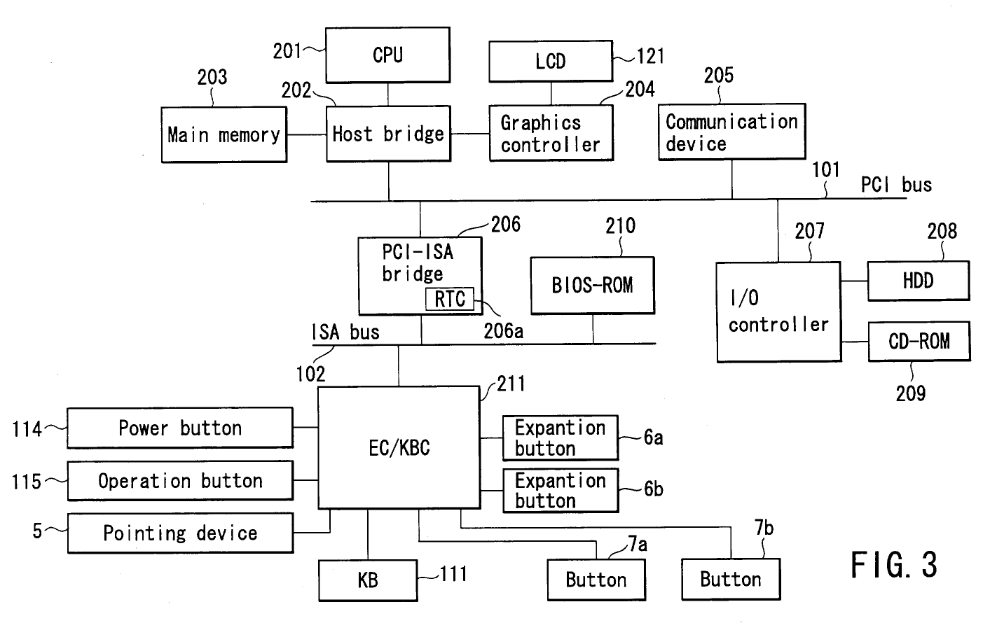

FIG. 3 shows the arrangement of the information processing apparatus 1 according to the embodiment of the present invention. As shown in FIG. 3, the information processing apparatus 1 comprises a CPU 201, host bridge 202, main memory 203, graphics controller 204, communication device 205, PCI-ISA bridge 206, I/O controller 207, hard disk drive (HDD) 208, CD-ROM drive 209, BIOS-ROM 210, embedded controller/keyboard controller IC (EC/KBC) 211, power supply controller 213, and the like.

The CPU 201 controls the operation of this computer, and executes an operating system and application program/utility program, which are loaded from the hard disk drive (HDD) 208 onto the main memory 203. The CPU 201 also executes a BIOS stored in the BIOS-ROM 210.

The host bridge 202 is a bridge device which connects a local bus of the CPU 201 and a PCI bus 101 in two ways. The graphics controller 204 controls an LCD panel 121 used as a display monitor of this computer. The communication device 205 is one of PCI devices, and is used to establish connection to a computer network (e.g., the Internet). The I/O controller 207 is another one of PCI devices, and incorporates an IDE controller or the like used to control the hard disk drive (HDD) 208 and CD-ROM drive 209.

The PCI-ISA bridge 206 is a bridge device which connects the PCI bus 101 and an ISA bus 102 in two ways, and incorporates various system devices such as a system timer, DMA controller, interrupt controller, and the like in addition to a real-time clock (RTC) 206a. The real-time clock (RTC) 206a is a timepiece module used to measure time, and manages time information such as year, month, day, day of the week, hour, minute, second, and the like. The time information of the real-time clock (RTC) 206a is used as a reference for a date and time managed by the operating system. The real-time clock (RTC) 206a always operates by its own battery.

The BIOS-ROM 210 stores the BIOS. This BIOS is a program for controlling hardware components in this system. This BIOS includes a function of reading time information from the real-time clock (RTC) 206a, a function of controlling the embedded controller/keyboard controller IC (EC/KBC) 211 to correct the time to be displayed on a sub LCD 116, and the like.

The embedded controller/keyboard controller IC (EC/KBC) 211 is a 1-chip microcomputer which integrates an embedded controller for power management, and a keyboard controller for controlling a keyboard 111.

This embedded controller/keyboard controller IC (EC/KBC) 211 has a function of turning on/off the power supply of this computer in response to user's operation on a power button 114 in conjunction with the power supply controller.

To the embedded controller/keyboard controller IC (EC/KBC) 211, the pointing device (stick) 5, expansion buttons 6a and 6b, down button (right button) 7a, and up button (left button) 7b shown in FIG. 1 are connected in addition to an operation button 115 (not shown).

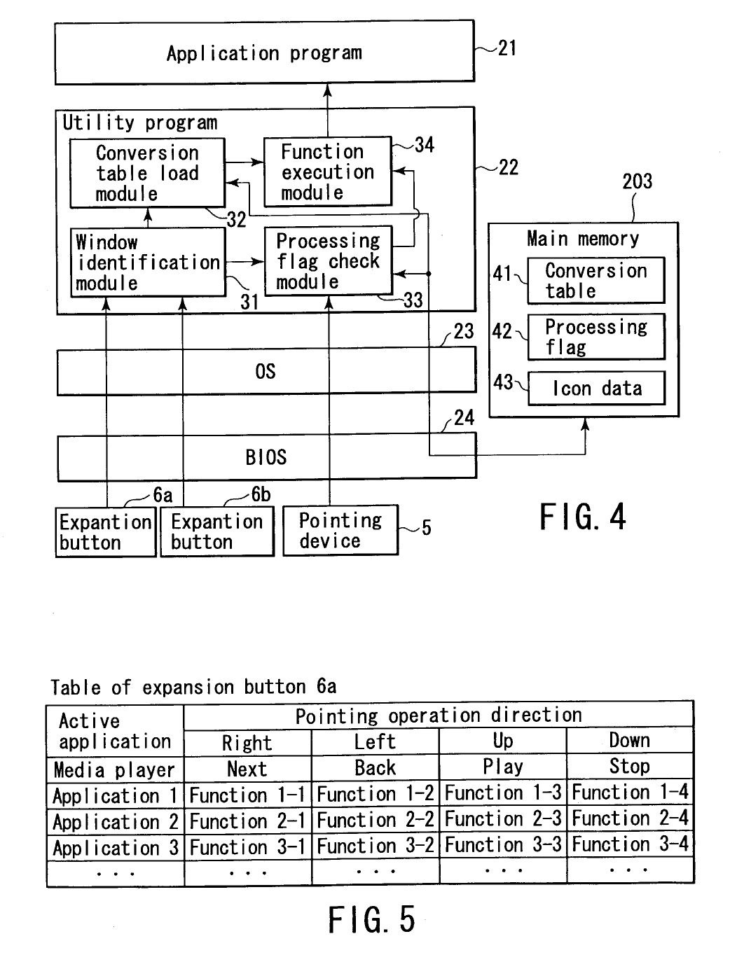

FIG. 4 is a functional block diagram of a utility program of the information processing apparatus according to the embodiment of the present invention.

As shown in FIG. 4, a utility program 22 is provided between an application program 21 and an OS (Operating System) 23 on a BIOS 24.

The utility program 22 has a window identification module 31, conversion table load module 32, processing flag checking module 33, and function execution module 34.

The window identification module 31 identifies an active application program window upon detection of depression of the expansion button 6a or 6b.

The conversion table load module 32 checks whether or not a conversion table 41 is present on the main memory 203, when the window identification module 31 has identified an active application program window. If the conversion table 41 is present, the module 32 loads the conversion table 41 from the main memory 203, and sets a processing flag 42 to ON; otherwise, the module 32 sets the processing flag to OFF.

The processing flag checking module 33 checks whether or not the processing flag 42 in the main memory 203 is ON, when a pointing operation is made using the pointing device 5. The module 33 notifies the function execution module 34 of the checking result and pointing operation.

If the processing flag 42 is ON, the function execution module 34 sends a command for executing a function corresponding to the pointing operation to the identified application program with reference to the loaded conversion table and in accordance with the active window of the identified application program. With this command, the active application program executes the function corresponding to the pointing operation.

Also, the module 34 sends icon data 43 which corresponds to the function to be executed and is stored in the main memory 203 to the application program as display data. In this manner, the display data corresponding to the function to be executed is displayed on the window.

FIG. 5 shows the conversion table.

As shown in FIG. 5, the conversion table 41 stores active application programs and functions of the pointing device for respective pointing operations in association with each other. FIG. 5 shows a table for the expansion button 6a. Also, another table is assured for the expansion button 6b.

For example, when an active application program upon depression of the expansion button 6a is a media player, a function of selecting the next song is assigned to a right pointing operation, and a function of selecting the previous song is assigned to a left pointing operation. Also, a play function is assigned to an up pointing operation, and a stop function is assigned to a down pointing operation.

FIG. 7 shows a dialog used to set such conversion table.

As shown in FIG. 7, the conversion table setup dialog allows the user to set functions for respective expansion buttons and applications, and for operations of the pointing device.

FIG. 7 shows the setup dialog for the expansion button 6a. In this case, a media player 51 is selected as an application program. A play function 52 is assigned to an up pointing operation, and a function 53 of selecting the previous song is assigned to a left pointing operation. Also, a function 54 of selecting the next song is assigned to a right pointing operation, and a stop function 55 is assigned to a down pointing operation. These functions can be selected using pull down menus 61 to 65.

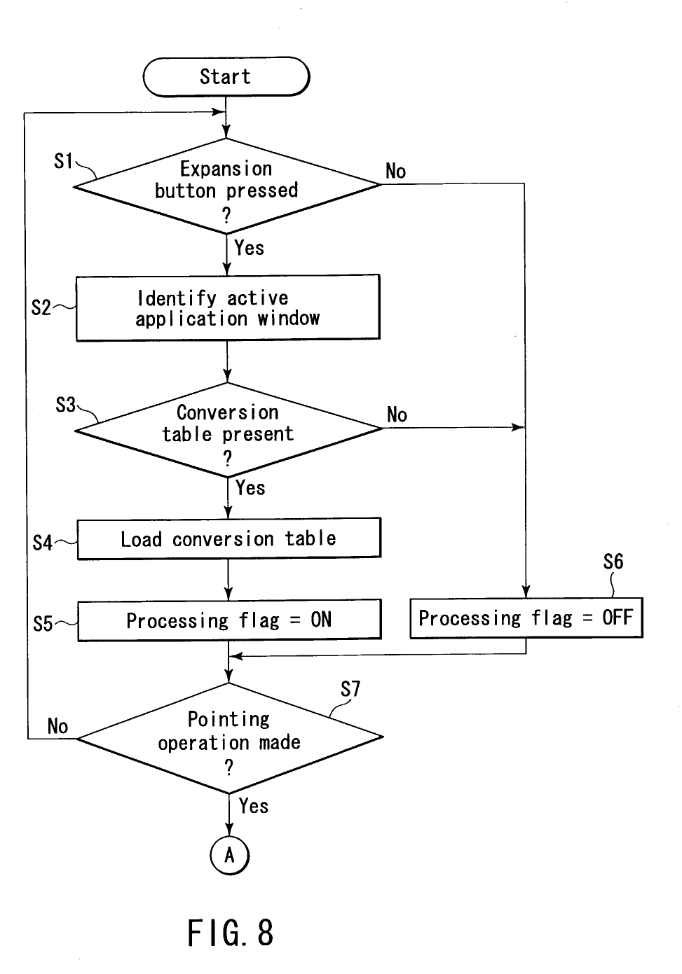

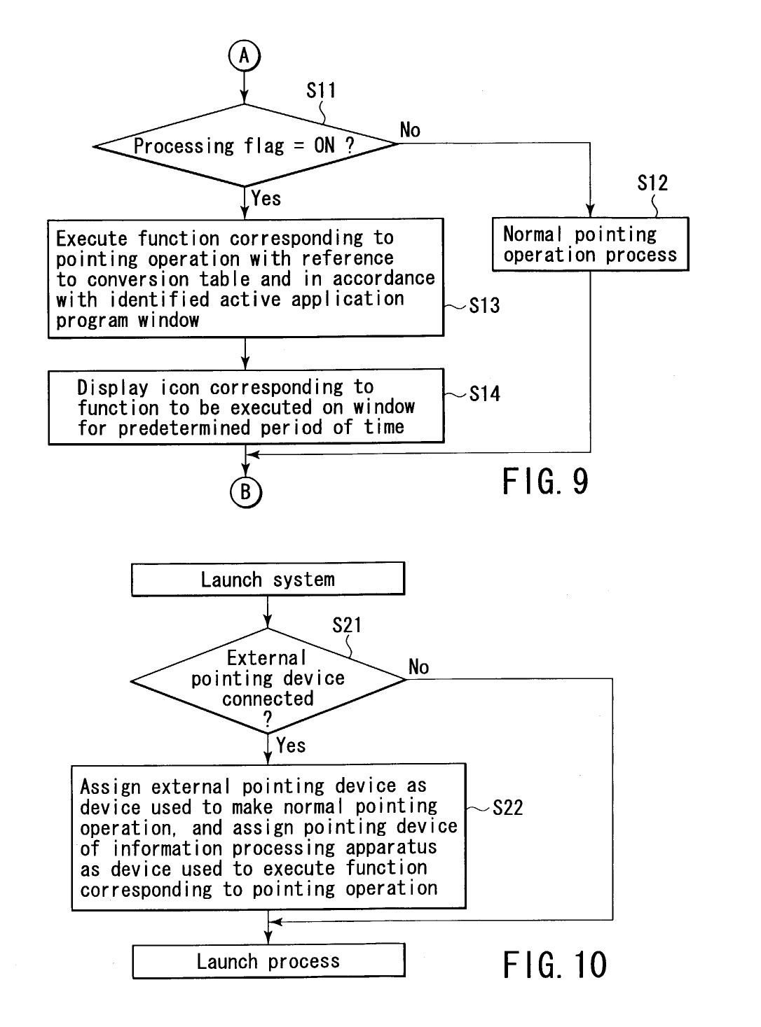

The operation of the information processing apparatus according to the embodiment of the present invention will be described below with reference to the flow charts of FIGS. 8 and 9.

The utility program 22 checks if one of the expansion buttons has been pressed (S1). If it is determined in step S1 that one of the expansion buttons has been pressed, an active application program window is identified (S2).

Note that an active application program window is identified on the basis of, e.g., the cursor position, an object to be operated, a function call of the operating system, or the like.

After that, the utility program checks if the conversion table is present (S3). If it is determined that the conversion table is present, the conversion table is read out from a registry (S4), and is mapped on the main memory. Then, the processing flag is set to ON (S5), and the utility program checks if a pointing operation has been made.

On the other hand, if it is determined in step S1 that no expansion button has been pressed, or if it is determined in step S3 that no conversion table is present, the processing flag is set to OFF (S6), and the flow advances to step S7.

If it is determined in step S7 that no pointing operation has been made, the flow returns to step S1. On the other hand, if it is determined that a pointing operation has been made, the utility program 22 checks if the processing flag is ON (S11). If it is determined in step S11 that the processing flag is not ON, a normal pointing operation process is executed (S12).

On the other hand, it is determined in step S11 that the processing flag is ON, a function corresponding to the pointing operation is executed with reference to the conversion table mapped on the memory and in accordance with the pressed expansion button and identified active application program window (S13).

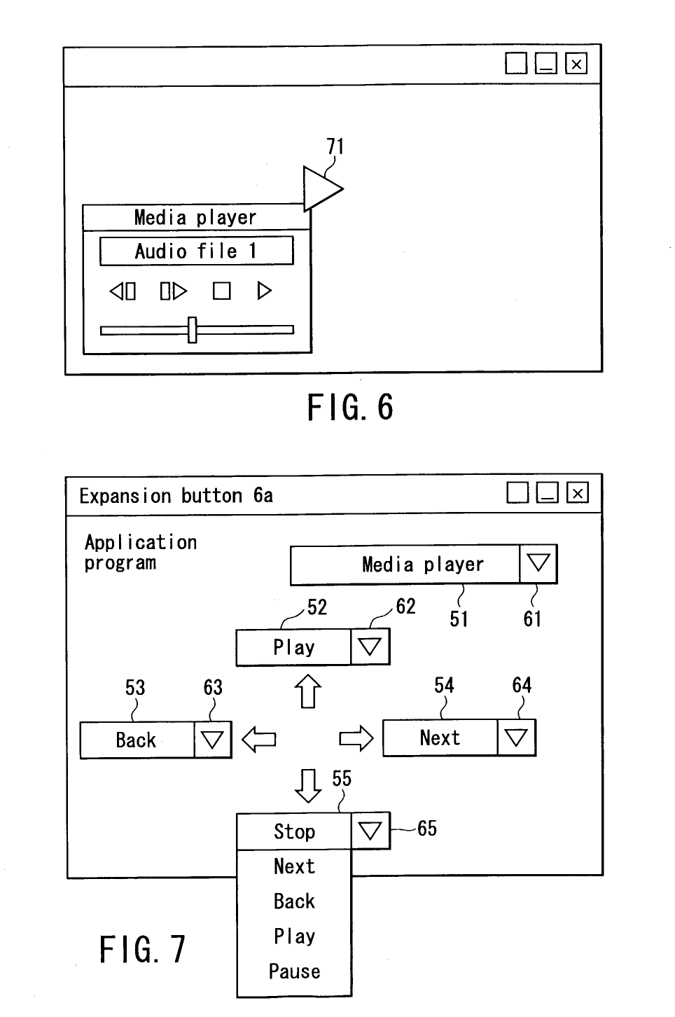

After that, an icon corresponding to the function to be executed is displayed on the window for a predetermined period of time (S14), and the flow returns to step S1. FIG. 6 shows a display state of an icon 71 corresponding to the play function to be executed when the user has operated the pointing device upward with the expansion button held down while the media player is active.

Therefore, according to the information processing apparatus of the embodiment of the present invention, when the user operates the pointing device while pressing the expansion button, a function corresponding to the pointing operation can be executed in accordance with the system environment. As a result, a function according to the system environment can be implemented by the pointing device without increasing the number of expansion buttons.

<Another Embodiment>

An information processing apparatus according to another embodiment of the present invention will be described below.

In another embodiment of the present invention, when a plurality of pointing devices are available, one pointing device is used to make normal pointing operations, and the other pointing device is used to execute functions corresponding to pointing operations in accordance with the system environment.

In this embodiment, the following case will be explained. That is, if an external pointing device is available, this external pointing device is used to make normal pointing operations, and the pointing device of the information processing apparatus is used to execute functions corresponding to pointing operations in accordance with the system environment.

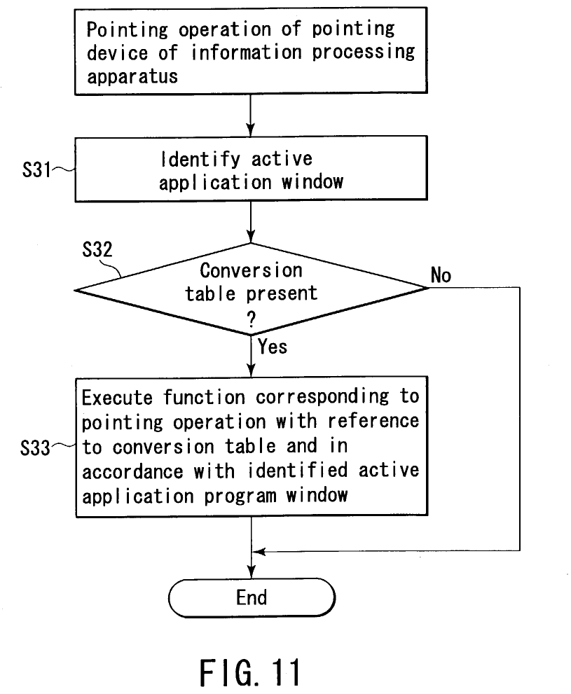

FIG. 2 shows a case wherein an external pointing device (mouse) 8 is provided to the information processing apparatus. FIGS. 10 and 11 are flow charts for explaining the operation of the information processing apparatus according to another embodiment of the present invention.

Referring to FIG. 10, if the system is launched, the utility program 22 checks if an external pointing device is connected (S21). If it is determined in step S21 that no external pointing device is connected, a launch process is executed.

In this embodiment, since the external pointing device (mouse) is connected, the flow advances to step S22. In step S22, the external pointing device is defined as a device used to make normal pointing operations, and the pointing device of the information processing apparatus is defined as a device used to execute functions corresponding to pointing operations. Then, the launch process is executed.

After the system launch process is completed, if the user has made a pointing operation of the pointing device of the information processing apparatus, an active application program window is identified (S31) as in the aforementioned embodiment.

Note that an active application program window is identified on the basis of, e.g., the cursor position, an object to be operated, a function call of the operating system, or the like.

After that, the utility program 22 checks if the conversion table is present (S32). If it is determined that the conversion table is present, the conversion table is read out from a registry, and is mapped on the main memory. Then, a function corresponding to the pointing operation is executed with reference to this conversion table and in accordance with the identified active application program window (S33).

That is, according to the information processing apparatus of another embodiment of the present invention, if a plurality of pointing devices are available, a role of executing functions corresponding to pointing operations in accordance with an active application program window is assigned to one of these pointing devices. Hence, various functions can be implemented using that pointing device without using any expansion buttons.

In the description of the above embodiments, a function corresponding to a pointing operation is executed in accordance with an active application program window. However, the present invention is not limited to an active application, but the function may be executed in accordance with any other kinds of information associated with the system environment such as a login user, a power supply connection state of the information processing apparatus, and the like.

Note that the present invention is not limited to the aforementioned embodiments, and various modifications may be made without departing from the scope of the invention when it is practiced. The respective embodiments may be combined as needed as long as possible, and combined effects can be obtained in such case. Furthermore, the embodiments include inventions of various stages, and various inventions can be extracted by appropriately combining a plurality of disclosed required constituent elements. For example, when an invention is extracted by omitting some of all constituent elements described in the embodiments, the omitted elements are compensated for by state-of-the-art techniques as needed upon practicing the extracted invention.

Also, the method described in each of the above embodiments can be delivered while being stored, as a program (software means) that can be executed by a computer, in a storage media such as a magnetic disk (floppy disk, hard disk, or the like), optical disk (CD-ROM, DVD, MO, or the like), semiconductor memory (ROM, RAM, flash memory, or the like), or being transmitted via a communication medium. Note that the program stored in the medium includes a setup program that sets up software means (including not only an execution program but also a table and data structure) to be executed in the computer. The computer which implements the apparatus of the present invention executes the aforementioned process by loading a program recorded on a recording medium or setting up software means by a setup program and controlling operations by this software means in some cases. Note that the recording medium is not limited to the delivery purpose, and includes a storage medium such as a magnetic disk, semiconductor memory, or the like arranged in the computer or a device connected via a network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a pointing device;
means for identifying an environment of the information processing apparatus; and
means for executing a function corresponding to an operation of the pointing device in accordance with the identified environment.

2. An apparatus according to claim 1, wherein the environment to be identified is an active window.

3. An apparatus according to claim 1, wherein the environment to be identified is a login user.

4. An apparatus according to claim 1, further comprising:
a table which stores the environment of the information processing apparatus and the function of the pointing device for pointing operations in association with each other,
wherein the identification means determines if a predetermined button is pressed, and identifies the environment of the information processing apparatus if the predetermined button is pressed, and
the execution means comprises:
means for, when the predetermined button is pressed, setting a processing flag to ON, and for, when the predetermined button is released, setting the processing flag to OFF;
means for determining if the pointing device is operated;
means for, when the pointing device is operated, determining if the processing flag is ON; and
means for, when the processing flag is ON, executing a function corresponding to the operation of the pointing device with reference to the table and in accordance with the identified environment of the information processing apparatus.

5. An apparatus according to claim 1, further comprising:
another pointing device different from the pointing device; and
a table which stores the environment of the information processing apparatus and the function of the pointing device for pointing operations in association with each other, and
wherein the another pointing device is used as a device used to make a pointing operation, and when the pointing device is operated, a function corresponding to the operation of the pointing device is executed with reference to the table and in accordance with the identified environment of the information processing apparatus.

6. An apparatus according to claim 1, further comprising means for displaying a setup dialog used to generate the table.

7. A method of assigning a function of a pointing device, comprising steps of:
identifying an environment of the information processing apparatus; and
executing a function corresponding to an operation of a pointing device in accordance with the identified environment.

8. A method according to claim 7, wherein the environment to be identified is an active window.

9. A method according to claim 7, wherein the environment to be identified is a login user.

10. A method according to claim 7, further comprising a step of:
displaying a setup dialog used to generate a table which stores the environment of the information processing apparatus and the function of the pointing device for pointing operations in association with each other.

11. A method according to claim 10, wherein the identification step includes a step of checking if a predetermined button is pressed, and identifying the environment of the information processing apparatus if the predetermined button is pressed, and
the execution step includes a step of executing a function corresponding to an operation of the pointing device with reference to the table and in accordance with the identified environment of the information processing apparatus.

12. A method according to claim 11, wherein the execution step includes steps of:
setting, when the predetermined button is pressed, a processing flag to ON, and setting, when the predetermined button is released, the processing flag to OFF;
determining if the pointing device is operated;
determining, when the pointing device is operated, if the processing flag is ON; and
executing, when the processing flag is ON, the function corresponding to the operation of the pointing device with reference to the table and in accordance with the identified environment of the information processing apparatus.

13. A method according to claim 7, further comprising steps of:
determining, upon launching a system, if an external pointing device is connected; and
assigning, when it is determined that the external pointing device is connected, the external pointing device as a device used to make a pointing operation, and assigning the pointing device of the information processing apparatus as a device used to execute a function corresponding to the pointing operation.

14. An information storage medium which stores a program for assigning a function of a pointing device in an information processing apparatus,
the program comprising:
means for identifying an environment of the information processing apparatus; and
means for making the information processing apparatus execute a function corresponding to an operation of the pointing device in accordance with the identified environment.

15. A medium according to claim 14, wherein the environment to be identified is an active window.

16. A medium according to claim 14, wherein the environment to be identified is a login user.

17. A medium according to claim 14, wherein the program further comprises means for displaying a setup dialog used to generate a table which stores the environment of the information processing apparatus and the function of the pointing device for respective pointing operations in association with each other.

18. A medium according to claim 14, wherein the identification means determines if a predetermined button is pressed, and identifies the environment of the information processing apparatus if the predetermined button is pressed, and
the execution means executes a function corresponding to an operation of the pointing device with reference to the table and in accordance with the identified environment of the information processing apparatus.

19. A medium according to claim 18, wherein the execution means sets a processing flag to ON when the predetermined button is pressed, and sets the processing flag to OFF when the predetermined button is released;
determines if the pointing device is operated;
determines if the processing flag is ON, when the pointing device is operated; and
executes the function corresponding to the operation of the pointing device with reference to the table and in accordance with the identified environment of the information processing apparatus, when the processing flag is ON.

20. A medium according to claim 14, wherein the program further comprises:
means for determining, upon launching a system, if an external pointing device is connected; and
means for assigning, when the external pointing device is connected, the external pointing device as a device used to make a pointing operation, and assigning the pointing device of the information processing apparatus as a device used to execute a function corresponding to the pointing operation.
